(19) United States
(12) Patent Application Publication
(10) Pub. No.: US 2004/0010489 A1
(43) Pub. Date: Jan. 15, 2004

(54) Method for providing search-specific web pages in a network computing environment

(75) Inventor: Rodger Sheldon Rio, Bozeman, MT (US)

Correspondence Address: WILLIAM B. KIRCHER, SHOOK, HARDY & BACON L.L.P., 1200 Main Street, Kansas City, MO, 64105-2118, US

(73) Assignee: RightNow Technologies, Inc.

(21) Appl. No.: 10/194,330

(22) Filed: Jul. 12, 2002

(51) Int. Cl. G06F 17/30; G06F 7/00

(52) U.S. Cl. 707/3

(57) ABSTRACT

A method and article for providing search-specific page sets and query-results listings is provided. The method and article provides end-users with customized, search-specific pages upon which to initiate a query. A method is also provided for defining the custom search page and the custom results page without the need for line-by-line computer coding. The present invention provides product and service information to end-users in an initiative format.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

This invention relates generally to computer program application development and the integration of geographic location and product-line information data with Internet-related software applications. More particularly, the present invention relates to a method and system for presenting geographic location information of an organization to an end-user over a data network. The geographic location information can include service-related information, custom information, driving directions, product line availability, contact information and visual mapping information.

Organizations often have an on-line presence that is separate and distinct from its physical presence. Maintaining such a distinction may make sense for business reasons, but the customer will usually not distinguish between a physical retailer and its virtual complement. Some customers are uncomfortable conducting on-line transactions over the Internet. These customers prefer an arm's length transaction offered at a physical store. Organizations, however, have a difficult time providing real-time, product-line information to customers in a customized form. The present invention resolves this disconnect by providing organizations with a method and system of linking customers with real-world purchasing options by connecting Internet users to brick-and-mortar stores via customized, search-specific search pages.

The present invention provides a product and method that allows an organization to configure multiple formats for accepting search-criteria entries and displaying search results. Currently, an organization that wishes to provide end-users with geographic location information must accept providing a single format for accepting search-criteria entries and a single format for displaying search results. An organization may be able to manually code complex and expensive computer programs to provide alternative search formats to end-users. A need exists to provide an organization, or a user, with a method, system, and article for configuring multiple search-criteria interfaces and multiple interfaces to display search results without having to code or contract out an expensive programming solution.

Organizations can typically provide the ability for end-users to search for limited geographic location information using conventional search-criteria fields such as city, state, or zip code. If, however, an organization offers unique products or wishes to empower its customers or staff with more descriptive and personal searching abilities, it must rely on expensive and time-consuming means such as processing phone calls and emails. The present invention solves this problem by providing a method for organizations to provide multiple custom search views to customers without line-by-line computer coding. Customized search views allow end-users to more efficiently search for geographic location information of an organization. A custom field can be used for gathering and displaying additional geographic location information of an organization. Custom fields can display special location information for a particular organization including the name of the owner or the identification of specified sales territories to which a location belongs.

The present invention also provides a method for assembling a Structured Query Language (SQL) statement that, when executed, returns results matching search criteria entered by an end-user.

### BRIEF SUMMARY OF THE INVENTION

The present invention is directed to a system, method, and article of manufacture for providing the ability to create and customize multiple search pages with different search criteria on each page and linked to a customized results display without complex, line-by-line computer coding. The search pages are provided to help customers find locations that satisfy the search criteria provided by an end-user. More particularly, the present invention is a software program product that performs the function of enabling businesses to provide multiple search views having different search criteria and results displays depending on what an end-user wishes to find.

The disclosed invention has several practical applications in the technological arts including enabling organizations to easily create multiple, customized search pages. It provides an organization with a development system and method for configuring multiple search-criteria interfaces and multiple search-results display interfaces without having to code or contract out expensive programming solutions. A view can be a unique display of a set of end-user pages. A view includes search criteria, views-links to other views, the sort order of display records, the formatting of displayed fields, the width of the fields displayed, and the number of records displayed per page. Search criteria includes search-criteria fields, a subset of which are selection-criteria controls, or selection criteria. Selection criteria are a subset of search criteria. Selection-criteria fields allow an end-user to make selections from a prepopulated list. For example, a drop-down menu is one type of control that could be used to display and solicit selection criteria. The aforementioned lists are not exhaustive. An organization can customize its views to display only the information that is most useful for its end-users or staff members. For example, an organization could add search criteria to show all locations carrying a specific product line or display custom field information for each location.

Among other aspects, the present invention is a software product for creating search-specific views. A user is able to quickly create customized search pages that an end-user can use to receive geographic product information of a business entity. Each view is made up of a unique set of custom search pages and results-display pages.

In one aspect of the invention, a software product is provided for defining a custom search page and including specific search criteria to be displayed on the custom search page. A custom results page can easily be defined for displaying a query result initiated by an end-user. Views-links, which are links to other views, can easily be included in the custom search pages. These views-links can be followed by an end-user to reach described views. Hyperlinks or selection controls, such as drop-down menus that list some or all of the available views, can easily be configured. Default values for selection criteria can be easily defined so that an end-user is greeted with popular selections.

The present invention allows for many search-criteria fields to be included on the custom search page, including custom fields created by the user. How the search-criteria fields are to be displayed can be configured, including creating labels to correspond to text boxes or selection criteria that describe the type of information solicited.

After an end-user submits a search request, the present invention will also construct and process a query from the data entered by the end-user into the search-criteria fields. The end-user will then be presented with a search results page displaying a grid that has a list of records with record-set headings matching the search-criteria entries. The results display is not limited to a grid format; results could also be merely listed on a page in a non-grid format. The present invention allows a user to easily format how a search-results page and corresponding records are displayed to an end-user. Thus, a custom results page can be defined with a custom display format, including designating a list of record headings to display to an end-user. The current invention allows a user to specify the display order for display fields to appear on the custom search page. For instance, certain headings may appear first or last. The present invention also allows a user to specify a sort order. This sort order can be based on at least one record heading. Some exemplary headings that can be chosen to be displayed include an organization's name, address, city, state, postal code, phone, fax, contact information, e-mail address, network address, product-line information, and mapping information.

In another aspect of the present invention, a custom search page can be connected to an end-user via a computer network such as the Internet. The custom search page can easily be associated with a network address, such as a Uniform Resource Locator (URL) or other logical address. Finally, the custom search page can be displayed to an end-user who navigates to the network address. A user can easily create multiple search pages and associate each with a network address so that search pages can be customized for end-users based on predefined target searches.

In another aspect of the invention, an organization is provided with a simplified method of creating a website to provide its location information to remote entities. The website provides end-uses with custom search pages tailored for specific searches, such as for finding store locations with certain product lines. The present invention makes it possible for a user to provide such custom search pages to end-users without having to type extensive computer code. The current invention allows an organization, without line-by-line computer coding, to provide for the processing of an end-user query.

In yet another aspect of the invention, geographic location information of an organization can be presented to an end-user by providing for the establishment of a logical connection with a remote computer, providing for a webpage to be downloaded containing search-specific search-criteria fields for accepting input from an end-user. The search-criteria fields are used by an end-user to input data used to create a query and return matching search results.

Other aspects of the invention will be made clear or become apparent from the following description and claims.

### BRIEF DESCRIPTION OF THE SEVERAL VIEWS OF THE DRAWING

The present invention is described in detail below with reference to the attached drawing figures, wherein:

FIG. 1A is a diagram of an exemplary operating environment suitable for practicing the present invention;

FIG. 1B is diagram of an exemplary database architecture suitable for practicing the present invention;

FIG. 2A is a block diagram illustrating an exemplary views topology of the present invention;

FIG. 2B is an illustration of an exemplary default view search page created by the present invention;

FIG. 2C is an illustration of an exemplary search-specific search page created by the present invention;

FIG. 3 is an illustration of a sample results listing created by the present invention;

FIG. 4 is an illustration of an exemplary SQL statement constructed and executed by the present invention;

FIG. 5A is a flow diagram illustrating how the present invention defines an end-user search view;

FIG. 5B is a flow diagram illustrating how the present invention defines selection criteria to search on;

FIG. 5C is a flow diagram illustrating how the present invention defines text fields to search on;

FIG. 5D is a flow diagram illustrating how the present invention defines a search-result records-set to display;

FIG. 5E is a flow diagram illustrating how the present invention defines search-result headings to sort on;

FIG. 6 is a flow diagram illustrating how the present invention renders an end-user view;

FIG. 7 is a flow diagram illustrating how the present invention generates an end-user custom search page;

FIG. 8A is a flow diagram illustrating how the present invention determines locations based on a view;

FIG. 8B is a flow diagram illustrating how the present invention builds a list of columns (fields) to select;

FIG. 8C is a flow diagram illustrating how the present invention builds a “SELECT . . . ORDER BY” clause of an SQL statement;

FIG. 8D is a flow diagram illustrating how the present invention builds a “WHERE” clause of an SQL statement;

FIG. 8E is a flow diagram illustrating how the present invention builds a “WHERE” conditional for latitude and longitude coordinates;

FIG. 8F is a flow diagram illustrating how the present invention builds “WHERE” conditional for selection-criteria fields;

FIG. 8G is a flow diagram illustrating how the present invention appends “WHERE” conditionals for selection-criteria fields;

FIG. 8H is a flow diagram illustrating how the present invention builds “WHERE” conditionals for text fields; and

FIG. 9 is a flow diagram illustrating how the present invention displays query results to an end-user.

### DETAILED DESCRIPTION OF THE INVENTION

As will be described in detail below, the present invention provides an organization with a method for developing and providing multiple search-specific page sets to an end-user without requiring the user to key line-by-line computer code.

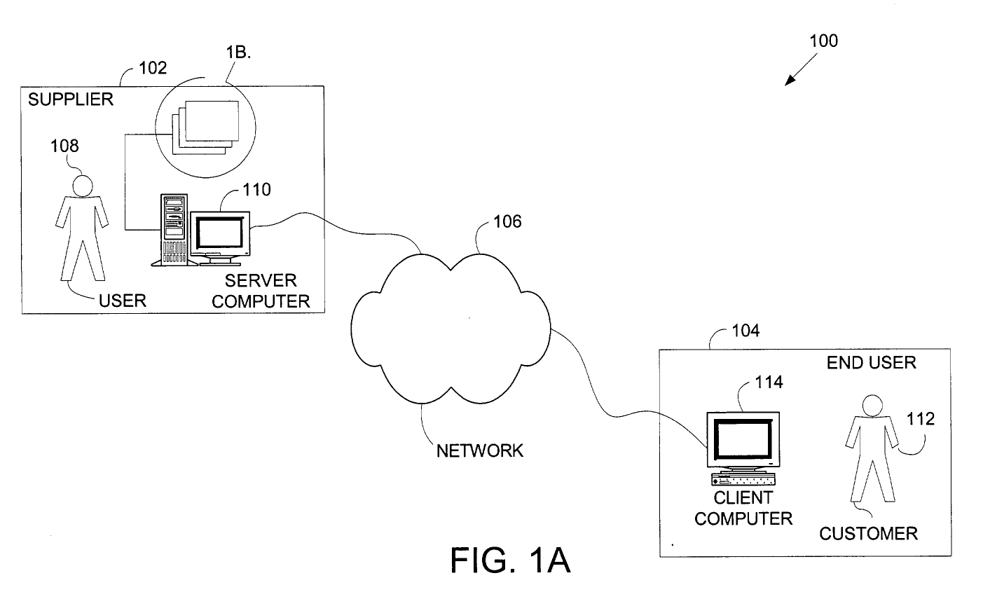

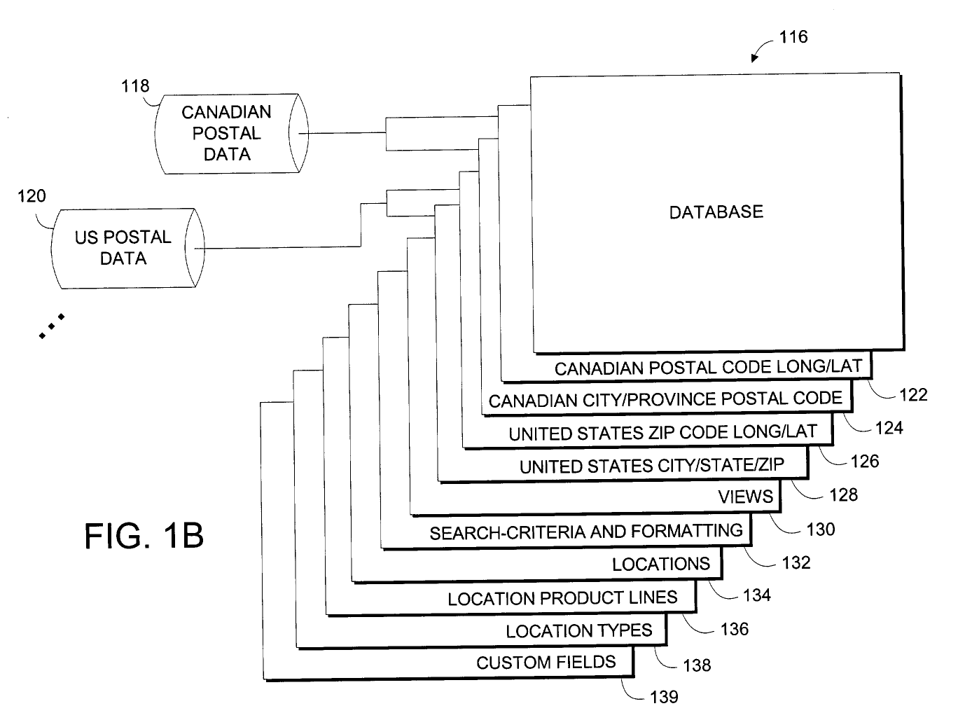

Referring now to the drawings in greater detail, and initially to FIG. 1A, an exemplary operating environment is referenced generally by numeral 100. Exemplary operating environment 100 is comprised of a supplier 102 logically coupled to an end-user 104 by a network 106. The present invention can be implemented by a user 108 on a server computer 110. A user 108 can be any person or entity who implements the current invention. An end-user 104 can be a customer 112 who accesses the present invention by client computer 114. End-user 104 can be any person or entity that makes use of the fruits created by the present invention. Server computer 110 and client computer 114 are not explained in detail due to their conventional nature. Server computer 110 and client computer 114 can be conventional computers, such as personal computers, with a processor, memory, and input and output devices to accept input and provide output data. Server computer 110 can be used to create the desired application, which is made available to end-user 104 at client computer 114 via network 106.

Network 106 is an exemplary network and can be the Internet, a local area network, or a wide area network. The Internet is a transport network, moving many forms of data around the world and is a network of computer networks that allows access, retrieval, and processing of virtually all manner of information. Network 106 can be any network that logically couples two computers with each other.

As will be explained below, the present invention enables a supplier 102 to customize multiple search pages for multiple target searches. An example of a target search would be a search for the availability of a specific product line at a specific physical store location. Accordingly, a preferred embodiment of the present invention is described as being practiced by user 108 who is enabled to create an application used by end-user 104. Server computer 10 is also logically coupled with a database comprised of a group of tables as illustrated in FIG. 1B.

Turning to FIG. 1B, an exemplary database illustrating a possible group of tables is reference generally by numeral 116. Exemplary database 116 could be a group of databases or tables and is used to provide geographic location information of an organization to an end-user 104. As shown, exemplary database 116 is comprised of multiple tables and is partially populated using external databases. A first external database 118 is used to populate database 116 with Canadian postal data. First external database 118 could be any database that provides Canadian postal longitude, latitude, and province data. An example of such a conventional database is provided by Professional Computer Consulting, Inc., a corporation of Fort Lauderdale, Fla., doing business as “GreatData.” A second external database 120 can be used to populate a United States Zip Code Longitude and Latitude table 126 and a United States City/State/Zip Code table 128. A provider of a suitable second external database 120 is Jay Computer Services of Lakeville, Minn. The aforementioned databases are exemplary databases and included for illustrative purposes. Other databases containing information about other geographic regions, such as the United Kingdom can also be included in the present invention.

Exemplary tables used in the present invention can include a Canadian Postal Code Longitude and Latitude table 122 and a Canadian City/Province Postal Code table 124. Other tables can include a views table 130, a search criteria and formatting table 132, a locations table 134, a location product lines table 136, a location types table 138, and a custom fields table 139. It is understood that the exemplary database 116 is described with respect to a preferred embodiment but is not meant to limit or restrict the present invention in any way. Exemplary database 116 is used to match data retrieved from customized views.

A view can be a unique display of end-user pages and can be comprised of a custom search page or pages and a custom results page or pages. The end-user 104 could be a member of an organization's staff, an organization's customer 112 as well as any other entity that seeks geographic location information related to the organization or its products and services.

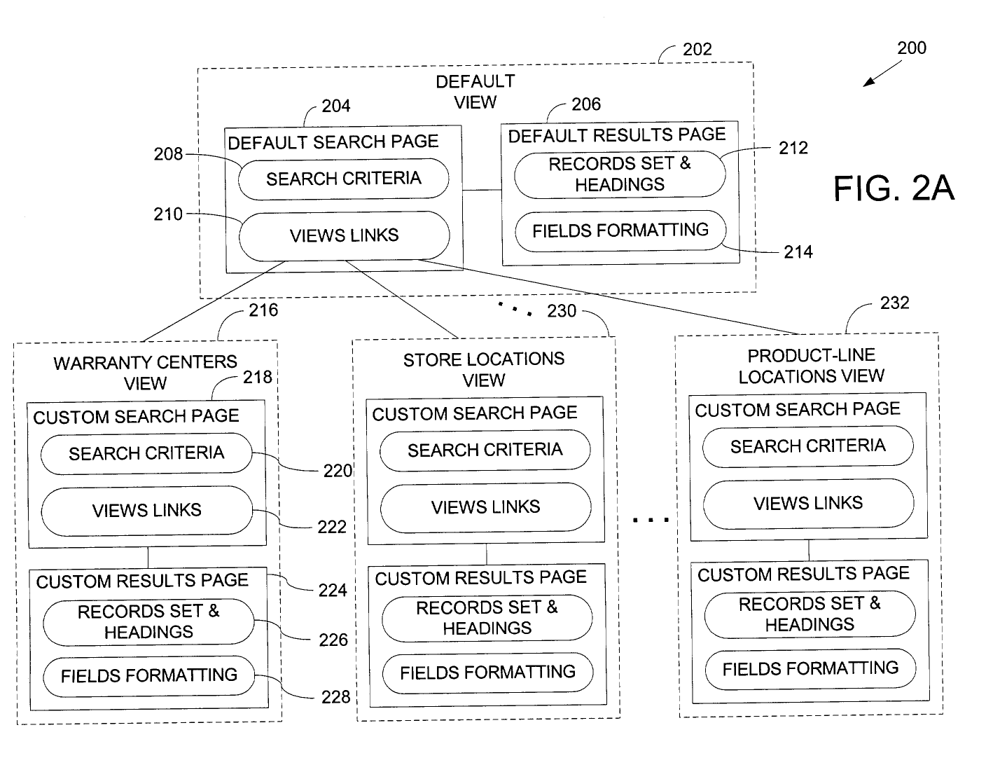

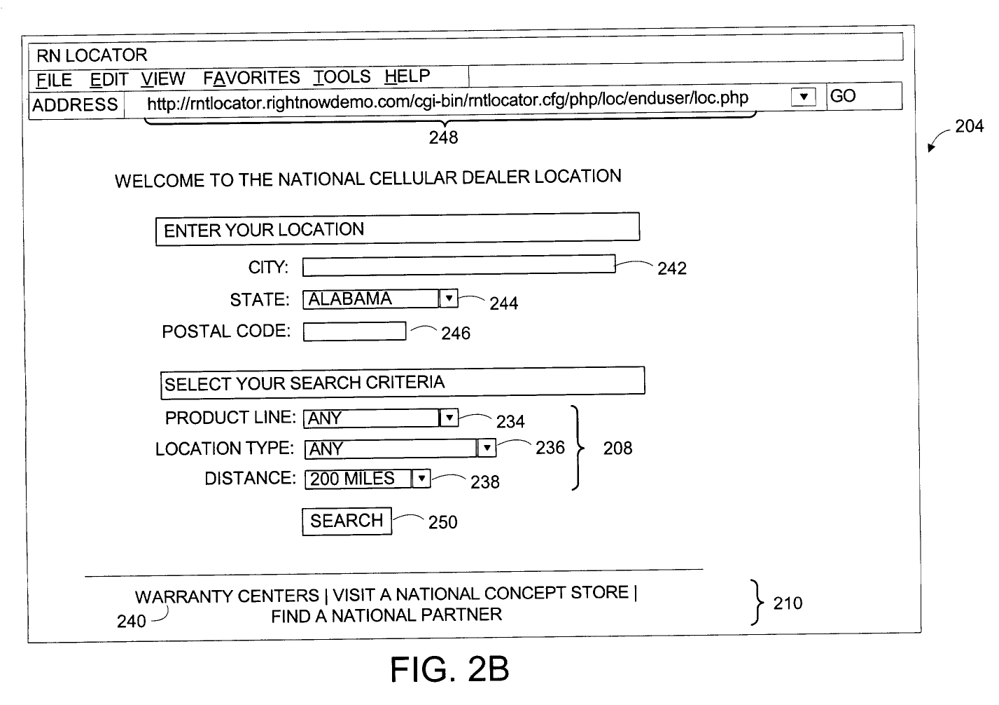

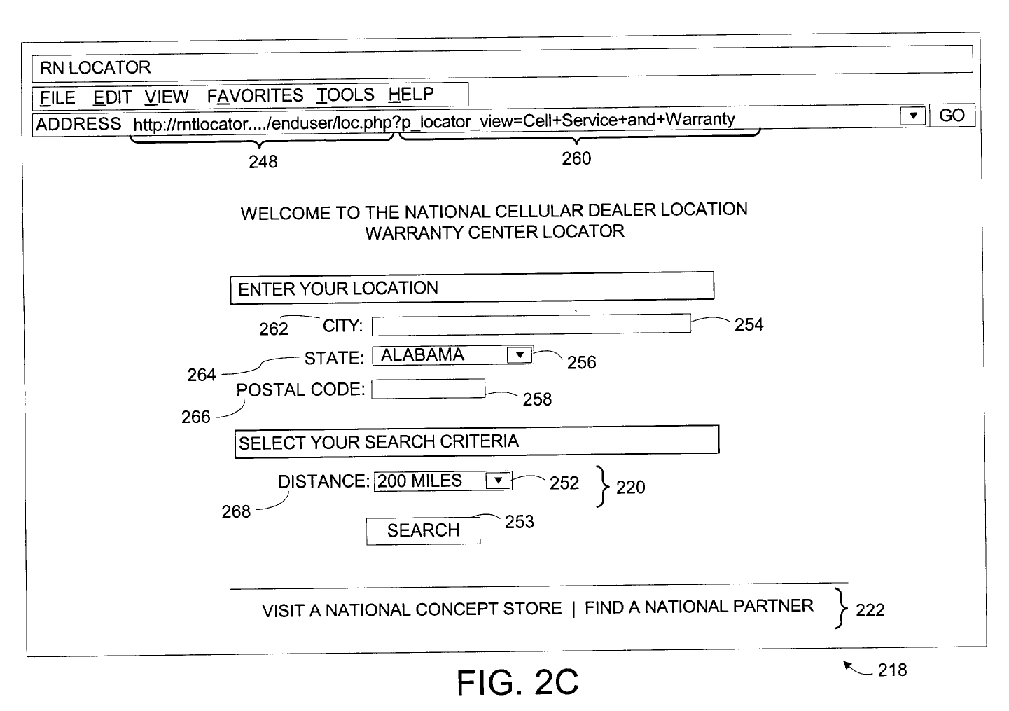

Turning now to FIG. 2A, an exemplary views topology is illustrated. User 108 can define multiple views as illustrated by FIG. 2A. One such view is a default view 202. Default view 202 is comprised of at least a default search page 204 and a default results page 206. The default view 202 can be customized like any other view. Default search page 204 includes a first set of search-criteria fields 208 and a first set of views-links 210. Default results page 206 includes a first set of records and record headings 212 and a first fields-formatting layout 214. Not all record headings need to be displayed to end-user 104.

As will be explained below, search criteria such as the first set of search-criteria fields 208 can include text boxes, drop-down menus and other controls to accept search selections made by an end-user 104. First views-links 210 are links to other views, which can be created using hypertext markup language (HTML). Three exemplary views are illustrated in FIG. 2A. These three exemplary views represent target searches designed and configured using the present invention by user 108. A first exemplary custom view is a Warranty Centers View 216. The Warranty Centers view 216 includes a custom search page 218. This custom search page 218 will be configured by user 108 to include a second set of custom search criteria 220 and a custom set of views links 222. Likewise, a custom results page 224 includes a second set of records-set and corresponding headings 226 and a second custom fields-formatting layout 228. Other exemplary views include a Store Locations view 230 or a Product-Line Locations view 232. Each of these customized views 216, 230, and 232 provide an end-user 104 with a customized, intuitive searching environment. Shown in FIG. 2A are merely four exemplary views. As many views as a user 108 desires to create can be created using the present invention without the use of line-by-line computer coding.

The current state of the art does not provide a way for a user 108 to customize search pages for an end-user 104. Absent the present invention, if an organization wishes to provide a page on its website whereby an end-user 104 could search for product-line locations available at specific stores, the supplier 102 must currently provide only a single search page, irrespective of the type of information that end-user 104 is seeking. This would typically result in an end-user 104 being faced with a search page including fields that are irrelevant to his or her search.

Turning now to FIG. 2B, an exemplary search page of a default view created by user 108 is referenced generally by numeral 204. Exemplary default search page 204 is an example of a search page that end-user 104 would see if no other views are provided by user 108. The present invention enables user 108 to create and define the default search page 204 including first search-criteria field set 208. First search-criteria field set 208 can include selection criteria such as a product line drop-down box 234, a location-type drop-down box 236, and a distance drop-down box 238. Each of these drop-down boxes 234, 236 and 238 contain elements defined by user 108. Also included in default view search page 204 are default views-links 210. An example of one such views-link is a Warranty Centers Location link 240. Following this link takes an end-user 104 to a view customized to search for nearby warranty centers. Default view search page 204 also includes additional data-entry fields for an end-user 104 to input data regarding his or her location. These fields can include a city text box 242, a state selection-criteria field 244, and a postal-code text box 246. Default view search page 204 can be associated with a first network address 248, which can be a URL or other network path. An end-user 108 may enter data into text fields and make selections from selection-criteria fields and initiate his or her search by pressing a search button 250.

Turning now to FIG. 2C, a custom search page of a search-specific view is referenced generally by the numeral 218. FIG. 2C is an exemplary custom search page of a search-specific view. The exemplary custom search-specific search page 218 is from the Warranty Centers view. Exemplary search-specific search page 218 includes second search criteria set 220. Here, the only search-criteria element is a single distance selection-criteria field 252. Other search-criteria element controls such as the location-type selection-criteria field 236 (FIG. 2B) are hidden from view. This creates a more intuitive search experience for end-user 104 because the location type “Warranty Center” does not need to be chosen or selected from a selection-criteria field. Search-specific search page 218 includes its own set of views-links 222. These views-links 222 link to other views of the user's 108 website. Data-entry fields for city, state and postal code are also included at reference numerals 254, 256, and 258. The network address of the exemplary search-specific search page 218 is comprised of the default network address 248 and a unique network address 260. Control labels are also included on the search-specific search page 218 as well as the default search page 204. Exemplary control labels include “city” 262, “state” 264, “postal code” 266, and “distance” 268. An end-user presses a search button 253 to return search results that are displayed on a custom search results page 224 (FIG. 2A).

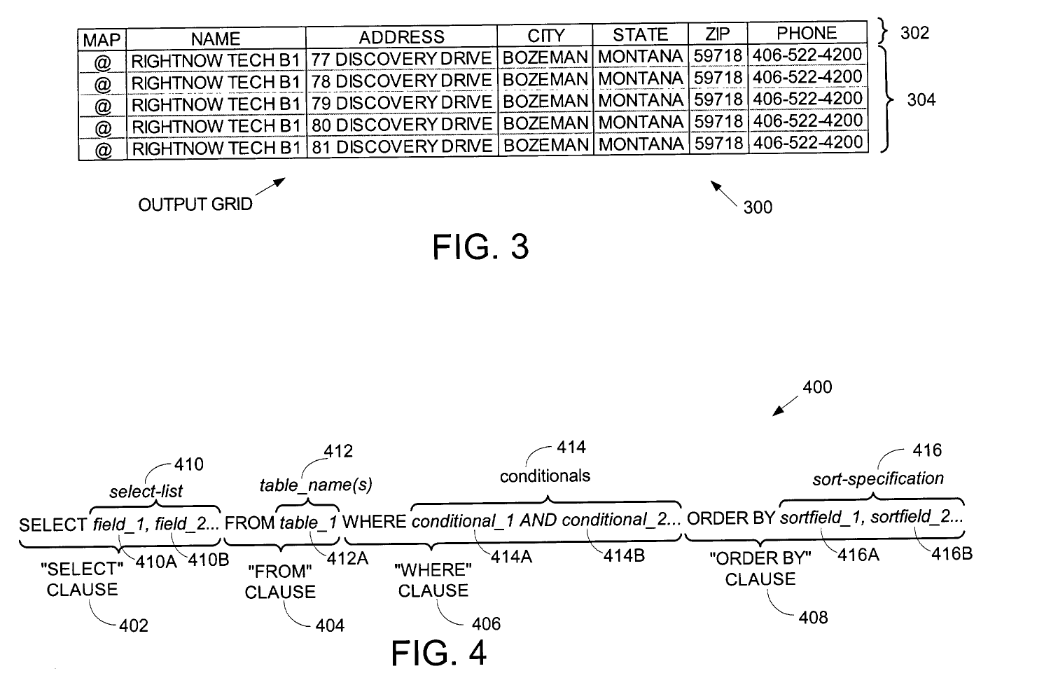

Turning now to FIG. 3, an exemplary results listing that could be depicted on a custom results page 224 is referenced generally by numeral 300. The display format of the exemplary results listing 300 can be defined and customized by user 108. Exemplary results listing 300 can be an output grid comprised of two main areas: a group of record-set headings 302 and a corresponding records set 304 returned by the present invention in response to an end-user's 104 search request. A grid-type format is merely one example of a presentation style of data to end-user 104. The output could simply be listed on a results page. The exemplary results listing 300, illustrates that the following non-exhaustive list of information can be returned by the present invention: mapping information, an organization's name, address, city, state, zip code and phone number. Although the exemplary listing 300 shows only certain record-set headings 302, any number of record headings could be chosen by user 108 to be displayed.

The display order of the record headings can also be dictated or defined by user 108 and implemented by the present invention without the need for line-by-line computer programming. As illustrated, an “Address” is shown in the third column, but it could be moved to the fourth, fifth, etc. The present invention also allows for the set of records 304 to be sorted by a sort order on one of the record headings 302. For instance, the set of records 304 could be sorted by “city” in ascending alphabetical order. Exemplary results listing 300 depicts data in columnar format. Presenting results in this format to an end-user 104 is only one of many possible formats for formatting data to be presented to an end-user 104 and is not intended to limit the scope or restrict the present invention. The present invention returns such an exemplary results listing 300 by processing a Structured Query Language (SQL) statement. The present invention includes a way of creating an SQL statement to provide the exemplary results listing 300.

Turning now to FIG. 4, an exemplary SQL statement is referenced generally by numeral 400. Exemplary SQL statement 400 is comprised of a “SELECT” clause 402, a “FROM” clause 404, a “WHERE” clause 406, and an “ORDER-BY” clause 408. The SQL statement 400 could contain other clauses not shown. The clauses listed, although used in a preferred embodiment, are not meant to impose any restrictions on the type of clauses that can be included in SQL statement 400.

The “SELECT” clause 402 includes a select-list element 410. The select-list element 410 specifies a list of column names or aggregate functions such as field_{—}1 410A and field_{—}2 410B to return the desired record set 304. The “FROM” clause 404 includes a table-name(s) element 412. The table-name element 412 can include names of tables such as table_{—}1 412A from which data is to be returned.

The “WHERE” clause 406 can include one or more conditionals 414. Together, the conditionals 414 describe rows of tables to be selected. Rows that match the specified conditionals 414 are returned upon execution of the SQL statement 400. Exemplary conditionals 414 may include conditional_{—}1 414A and conditional_{—}2 414B. Any number of conditionals can be joined by Boolean connectors to create conditionals 414 that will retrieve a desired record set 304.

The “ORDER-BY” clause 408 includes a sort-specification element 416 describing how to sort the resulting rows. The sort-specification 416 can include a plurality of sort fields such as sortfield_{—}1 416A and sortfield_{—}2 416B, which could be a column name and a sort direction such as ascending, descending.

Creating End-User Search Views

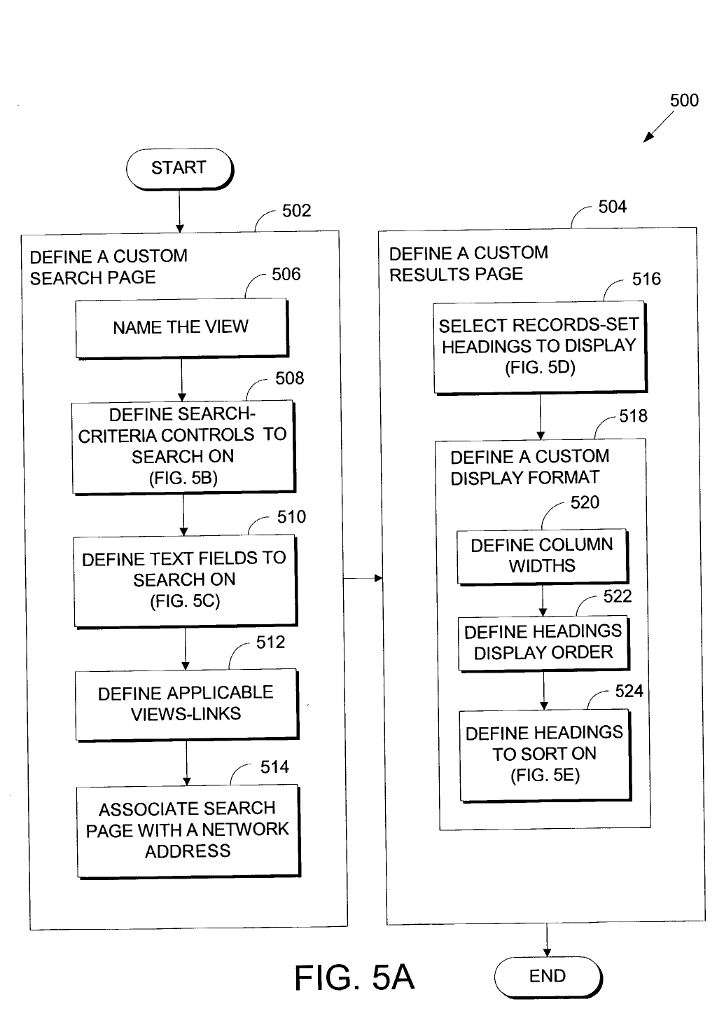

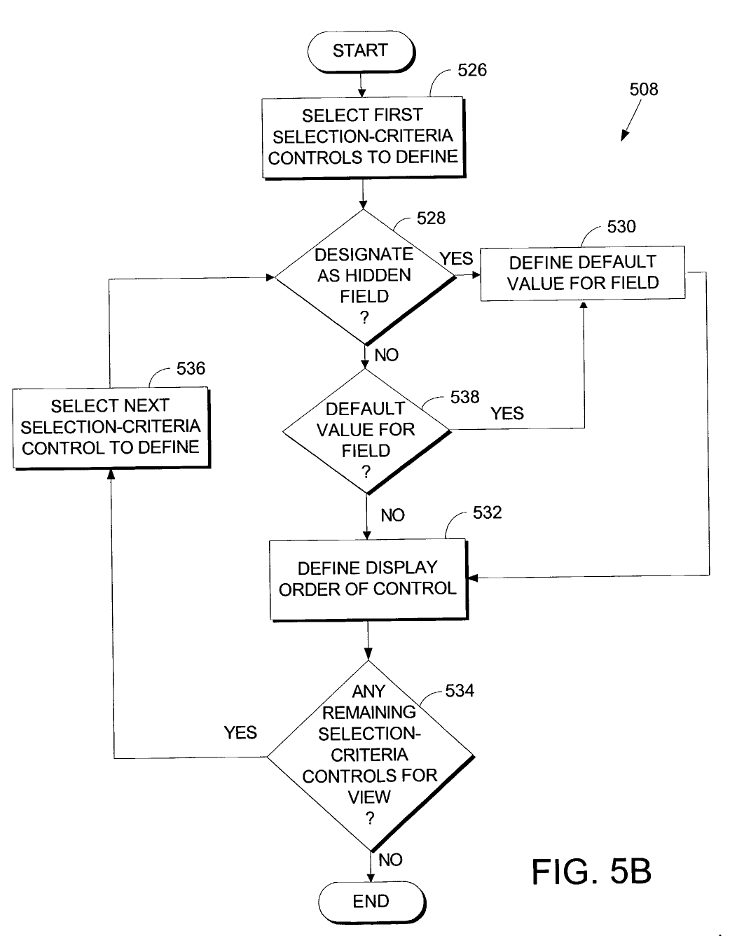

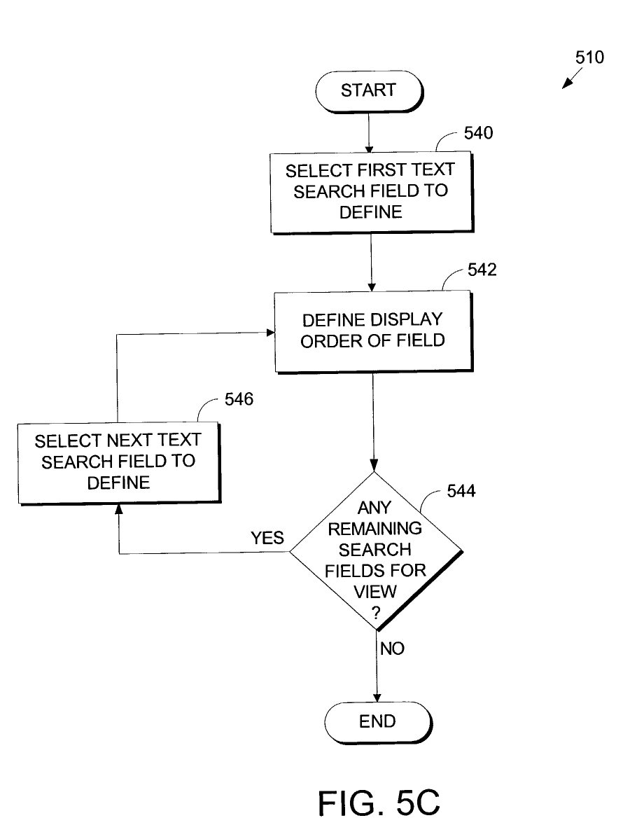

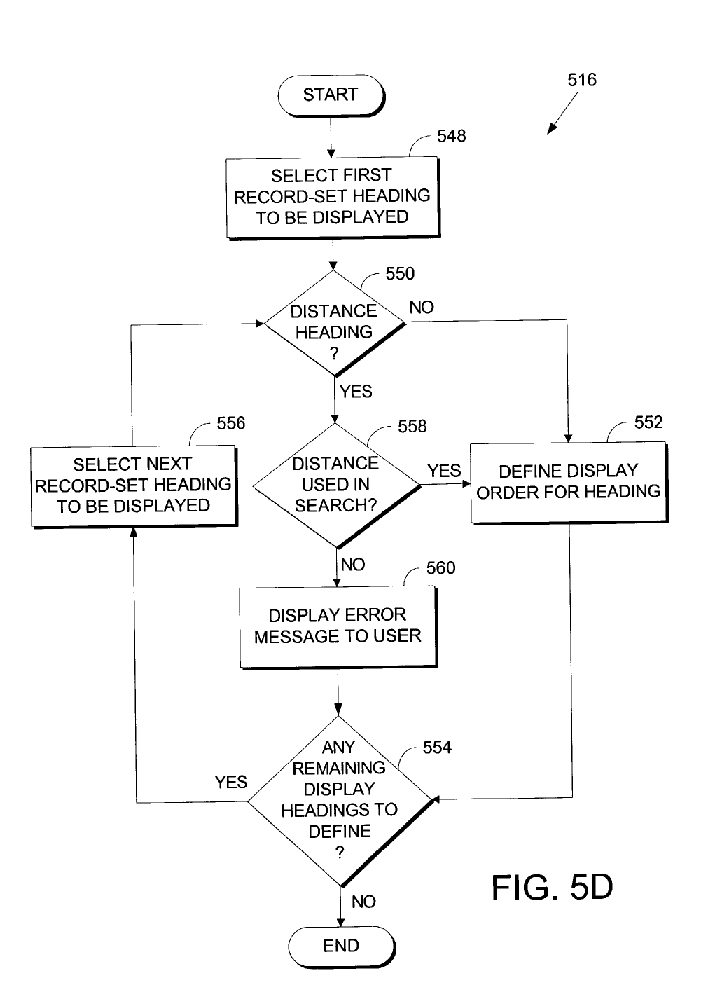

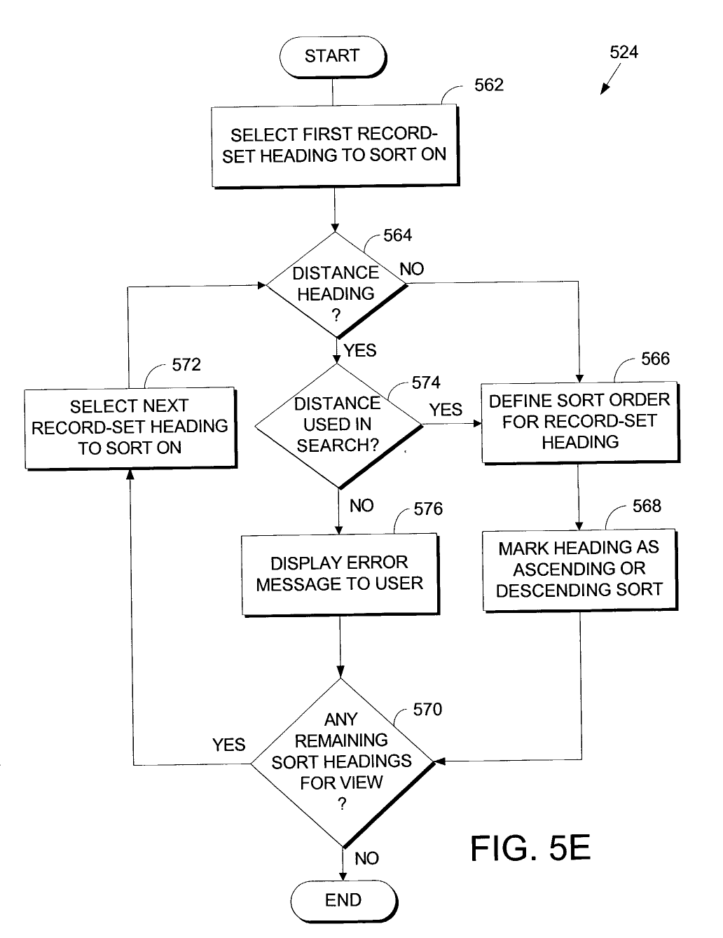

As described earlier, the present invention provides a method and system for creating multiple end-user search views without line-by-line computer coding. Turning now to FIG. 5A, a process of defining an end-user search view is provided and referenced generally by numeral 500. A user 108 can use the present invention to define an end-user 104 search view. Defining an end-user search view is comprised of two steps. In a preferred embodiment, a user 108 defines a custom search page at a step 502 and defines a custom results page at a step 504.

Defining a custom search page can comprise five steps. At a step 506, user 108 names the view. In this illustration, a view is comprised of a custom search page and a custom results page. The following example will be provided wherein the present invention is used to create the Warranty Center Locator view 216, comprised of the search-specific search page 218 and exemplary results listing 300 on custom results page 224. After naming the view, the present invention is used to define selection-criteria controls to search on at a step 508, which will be further explained with reference to FIG. 5B.

Next, the present invention allows user 108 to define text fields to search on at a step 510, which will be described in greater detail with reference to FIG. 5C. These text fields help make up the search criteria used to solicit data from an end-user 104 upon which the present invention can search. Next, applicable views-links can be defined at a step 512. It is not necessary to define a views-link. A last step in defining a custom search page can involve associating the search page with a network address at a step 514.

A next step of defining an end-user search view is to define a custom results page at step 504. Defining a custom results page can involve two steps. First, the present invention provides user 108 with the ability to select records-set headings 302 to display at a step 516, which will be further explained with respect to FIG. 5D. In a preferred embodiment, record-set headings are column headings. A record-set heading 302 could be any heading that describes a corresponding records-set 304.

A second step of defining a custom results page includes defining a custom display format at a step 518. Defining a custom display format at a step 518 could include, among other things, defining column widths at a step 520, defining a headings display order at a step 522, and defining headings to sort on at a step 524. Record-set headings 302 can be sorted on without being displayed. For instance, a records-set 304 could be sorted by distance even though “DISTANCE” is not a displayed record-set heading.

Defining column widths at step 520 includes allowing the user to designate column widths for a set of records 304 returned from the query. Which record-set headings 302 are to be displayed can also be designated using the present invention. Defining the display order of record-set headings 302 at a step 522 includes determining which record-set headings 302 appear left-most. Defining a sort order of records-set 304 at a step 524 includes designating certain record-set headings 302 to be sorted on. An ascending or descending order can be designated and will be discussed in greater detail with reference to FIG. 5E.

Turning now to FIG. 5B, a process for defining selection-criteria fields to search on is referenced generally by numeral 508. A drop-down menu is one type of selection-criteria control used by the present invention to solicit information from an end-user 104 on which to initiate a search. Other exemplary controls used for soliciting information could include text boxes, check boxes, etc. Each of these search-criteria controls can be customized using the present invention, including their placement, size, and location on the search page 218. At a step 526 the present invention allows a user to select a first selection-criteria field to define. The chosen field can be designated as a hidden field. A determination is made whether the chosen field is designated as a hidden field at a step 528. If the field is to be a hidden field, a default value is defined for that field at a step 530.

An example of hiding a field would include setting up search-specific search page 218 such that the “location type” selection-criteria field 236 is hidden and prepopulated with a value corresponding to that used to find Warranty Center Locations. As illustrated in FIG. 2C, the “location-type” selection-criteria field 236 is not shown. An end-user would not see the location-type selection-criteria field 236 on the search-specific search page 218 because it is specific to locating Warranty Centers.

Next, the display order of the field can be defined at a step 532. A determination is made as to whether there are any remaining search fields to define for the view at a step 534. If there are, the present invention allows for a selection of the next selection-criteria field to be defined at a step 536. Again, a determination is made as to whether the field is to be designated as hidden or not at step 528. If the field is not to be designated as hidden, then a determination is made as to whether the user 108 wishes to include a default value for the selection-criteria field at a step 538. If so, a default value for the field is defined at step 530; if not, an option to define the display order of the field is provided to user 108 at step 532. The process for defining selection-criteria fields to search on can be repeated for as many selection-criteria fields as the user 108 desires to create.

Turning now to FIG. 5C, a preferred process for defining text fields to search on is referenced generally by numeral 510. At a step 540, a first text search field to define is selected. An exemplary text field includes the “city” text field 254. A display order for the text search field can be defined at a step 542. Next, a determination is made as to whether there are any remaining text search fields for this specific view at a step 544. If so, the present invention allows the next text search field to be defined at a step 546. This process is repeated as many times as necessary to define as many text boxes for text fields that a user 108 wishes to make available to an end-user 104 to search on. The present invention allows for the creation of custom text fields, which can be displayed to the end-user as part of the grid output 300.

Turning now to FIG. 5D, a preferred process for defining which search result record-set headings 302 to display is referenced generally by numeral 516. At a step 548, the present invention allows a first record-set heading to be selected. At a step 550, a determination is made as to whether the record-set heading is a distance heading. If it is not, then a display order for the record-set heading can be defined at a step 552. The display order of exemplary results listing 300 corresponds to a left-most column designation. At a step 554, a determination is made as to whether there are any remaining display headings to define. If so, the next record-set heading to be defined is selected at a step 556. Again, a determination is made as to whether the selected heading is a distance heading at step 550. If it is a distance heading, then a determination is made as to whether distance was used in the search at a step 558. If so, the display order can be defined at step 552. If distance was not used in setting up the search, then an error message is displayed to user 108 at a step 560. This process can be repeated as many times as are necessary to define as many record-set headings to display to an end-user.

Turning now to FIG. 5E, a process for defining which record-set headings 302 to sort on is referenced generally by numeral 524. At a step 562, a first record-set heading to sort on can be selected by user 108. At a step 564, a determination is made as to whether a record-set heading selected in step 562 was a distance heading. If the heading chosen was not a distance heading, then a sort order for the records-set heading can be defined at a step 566. Depending on whether a user 108 wishes to designate the records-set heading as being sorted in ascending or descending order, the heading is marked as an ascending or descending sort at a step 568. A determination is made at a step 570 as to whether there are any remaining sort headings for this specific view. If so, the next record set heading to sort on is selected at a step 572, and a determination as to whether the heading selected was a distance heading is made at step 564. If the heading is a distance heading, then a further determination is made at a step 574 as to whether distance was used in the search. If a user 108 did set up distance to be used in a search, then the present invention will allow a sort order for a record-set heading to be defined at step 566. Next, the record-set heading will be marked as either ascending or descending at step 568 depending on whether user 108 selected ascending or descending sort order. If distance was not used in the search, then an error message would be displayed to user 108 at a step 576. This process can be repeated for as many numbers of search-result headings to be included in the results listing 300.

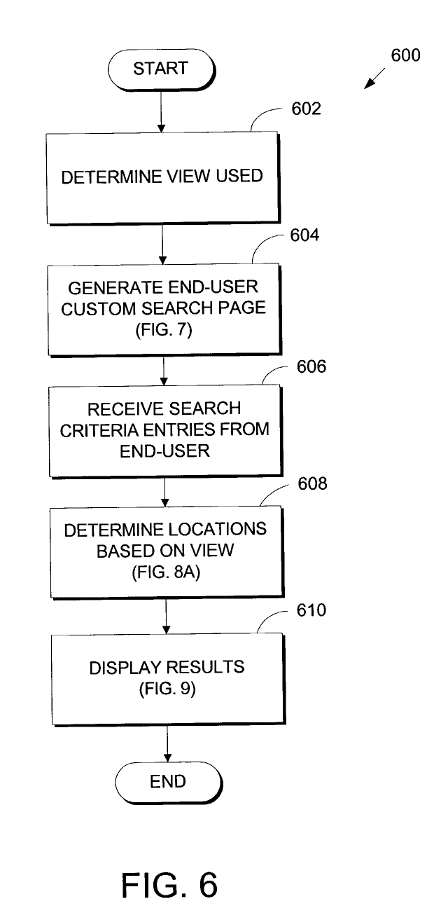

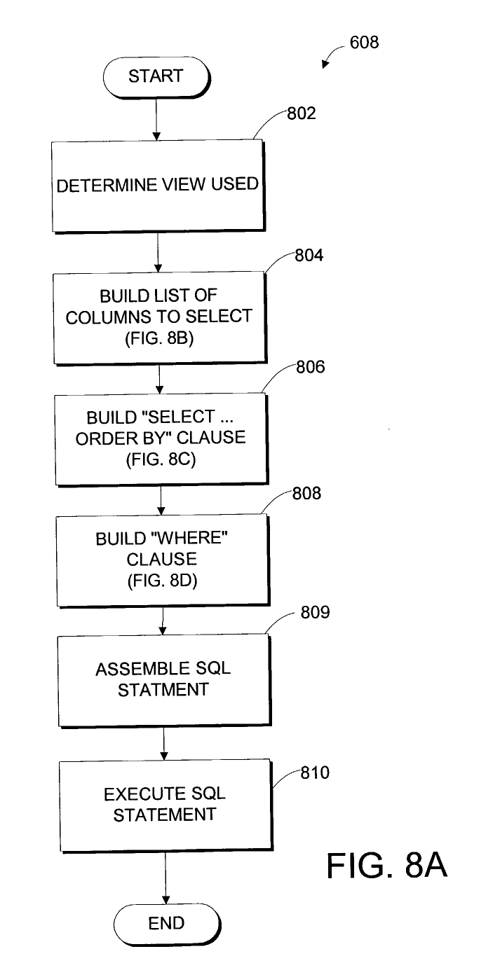

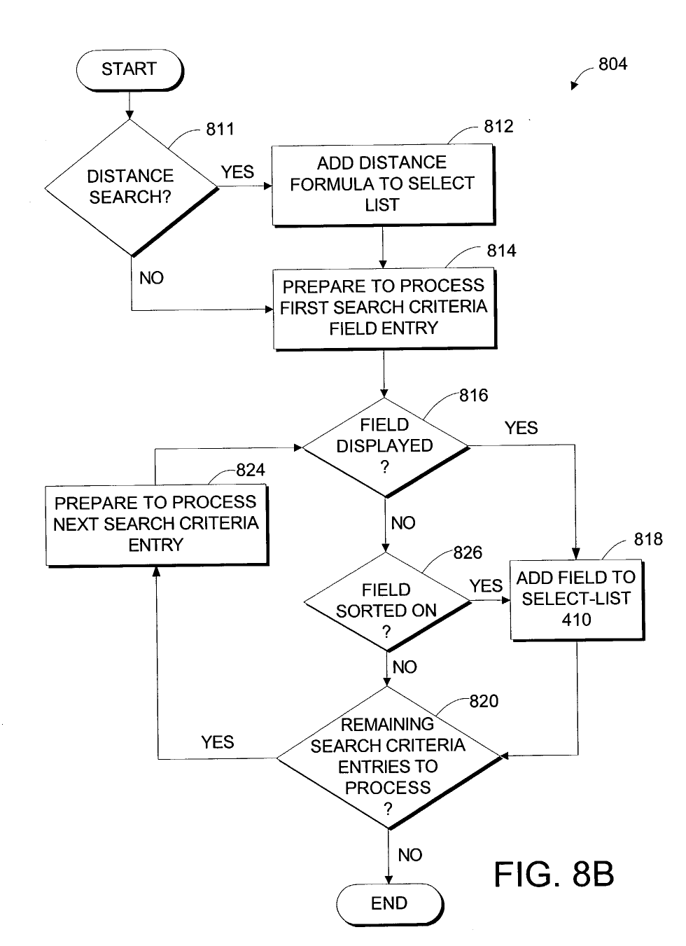

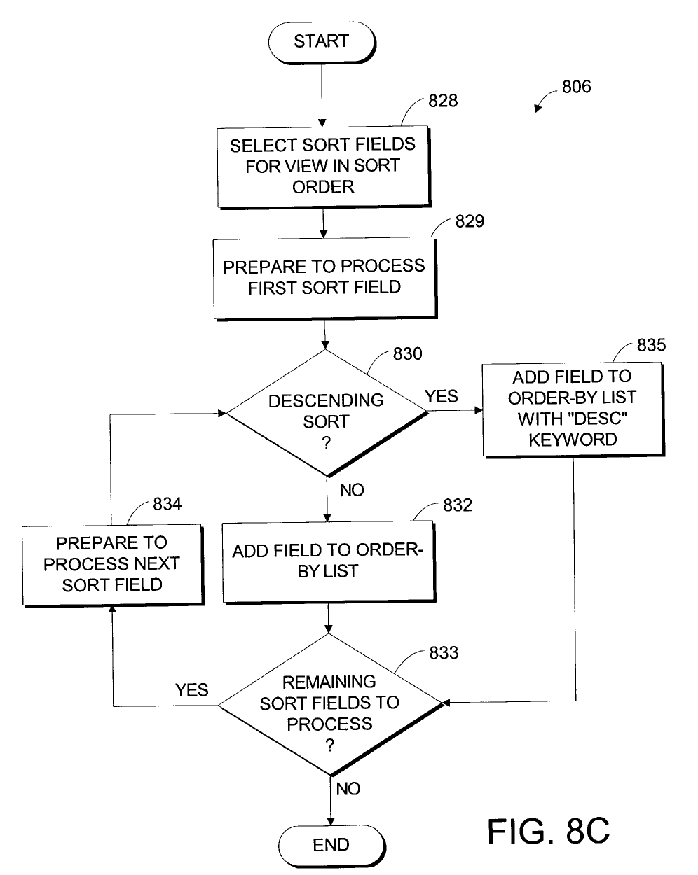

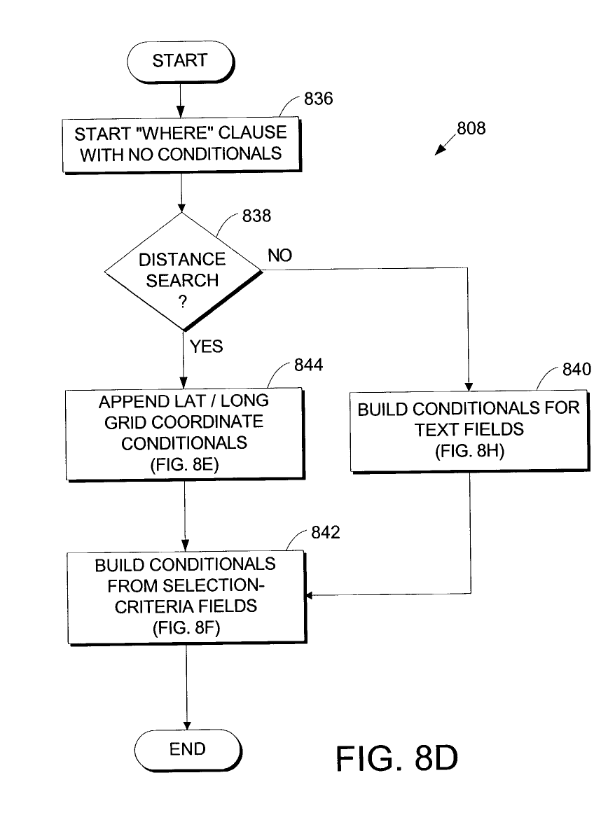

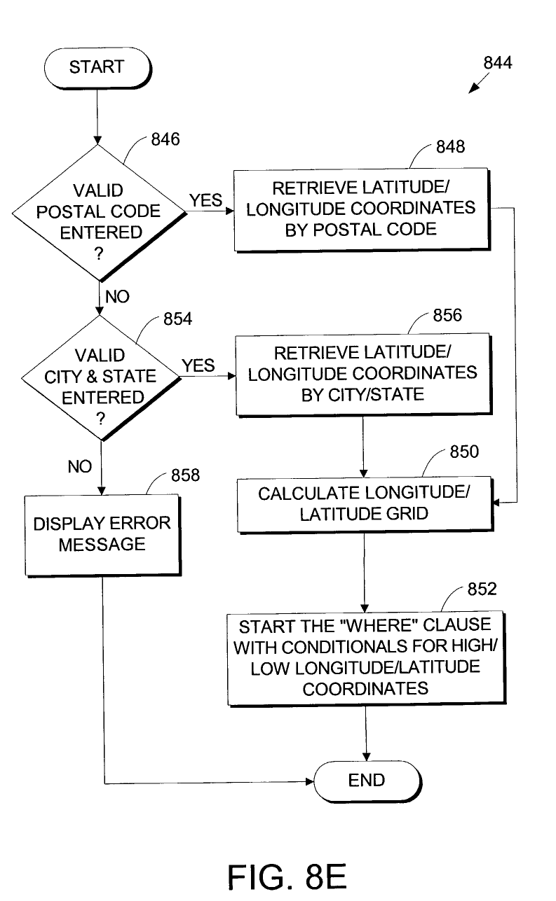

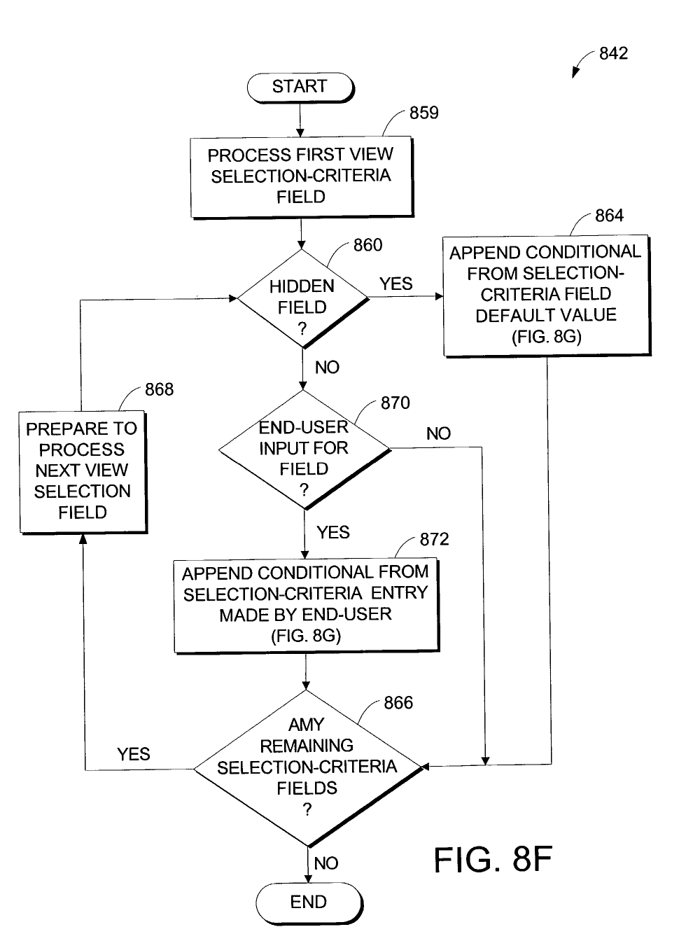

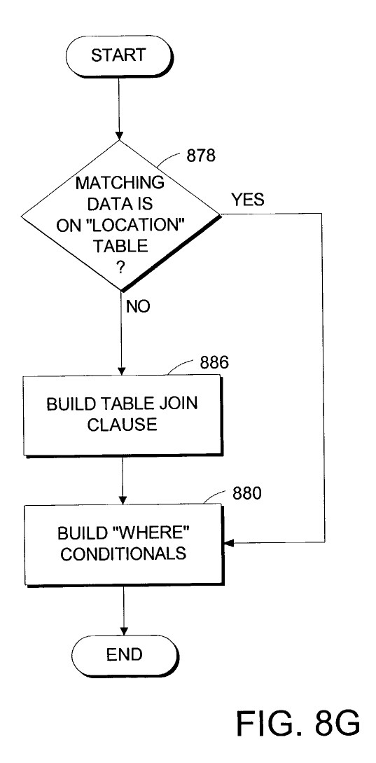

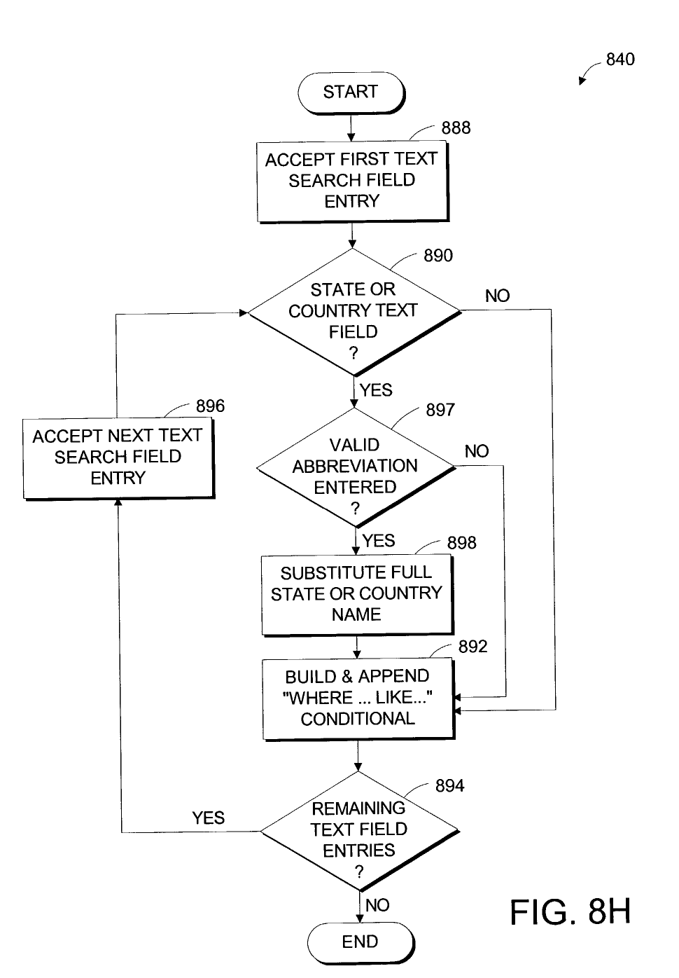

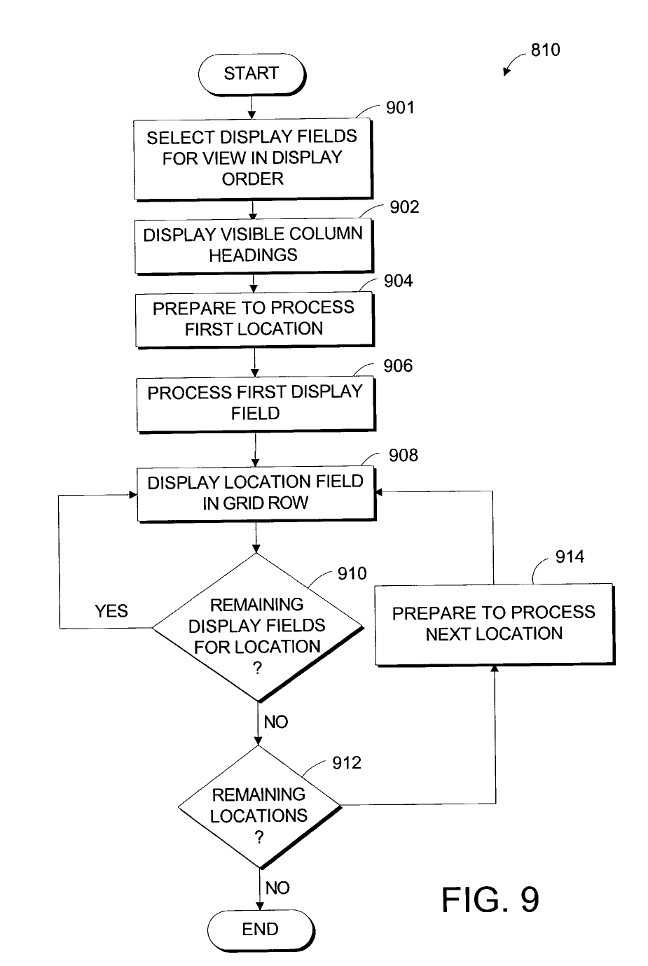

Turning now to FIG. 6, a process the present invention uses to generate an end-user search view is referenced generally by the numeral 600. At a step 602 the present invention determines which view is used. As described above, this determination is made by referencing a network address associated with a specific view. At a step 604 the present invention generates an end-user custom search page. At a step 606, search criteria entries from an end-user 108 are received. At a step 608 the present invention determines an organization's locations based on the specific view, which will be illustrated in greater detail with reference to FIG. 8A. Finally, at a step 610 the display results are displayed to an end-user 104, which will be explained in greater detail with reference to FIG. 9.

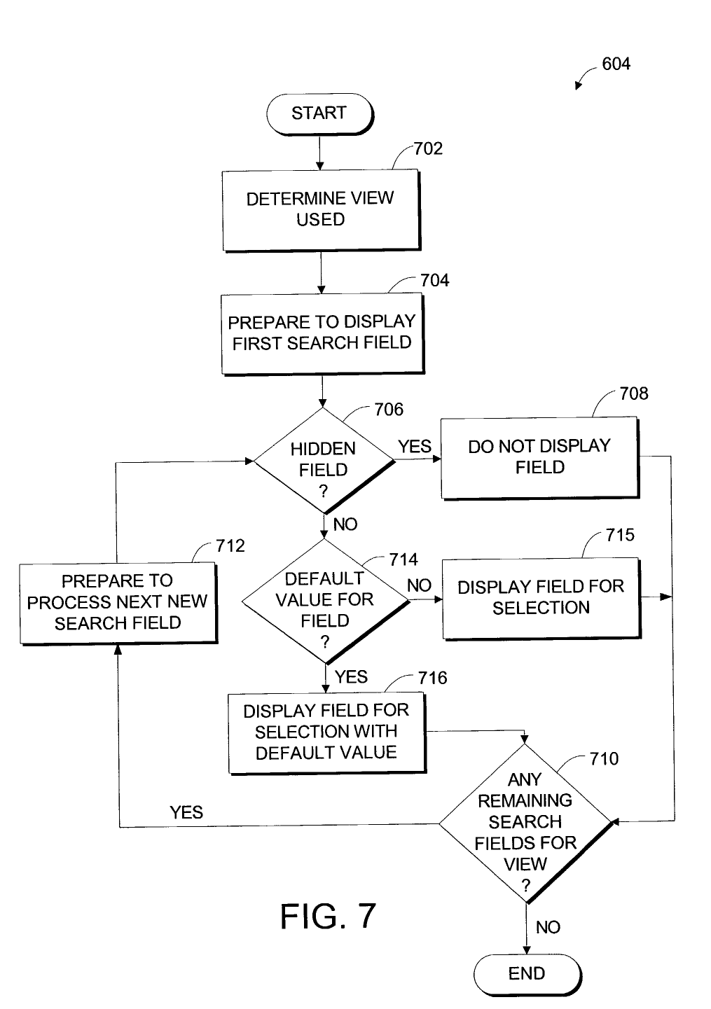

Turning now to FIG. 7, a preferred process for generating an end-user custom search page is referenced generally by numeral 604. At a step 702 the present invention determines which view to use. Next, the present invention prepares to display the first search field at a step 704. A determination is made at a step 706 as to whether the first search field is a hidden field. If the first search field is a hidden field, the present invention will not display the field at a step 708. At a step 710, a determination is made as to whether there are any remaining search fields for this specific view. If so, the present invention prepares to process the next view search field at a step 712. Again, a determination is made as to whether the field is hidden at step 706. If the next search field is not a hidden field, then a determination is made as to whether there is a default value for the field at a step 714. If there is no default value, then that specific display field is made available for selection at a step 715. If, however, there was a default value for this field, then the field is displayed for selection but is prepopulated with a default value at a step 716. Again, a determination is made as to whether there are any remaining search fields for this view at step 710. If not, the process ends.

Turning now to FIG. 8A, a preferred process for determining locations based on a view is referenced generally by numeral 608. First, the specific view that is to be used is determined at a step 802. Next, a list of columns to select is built at a step 804, which will be explained in greater detail with reference to FIG. 8B. Next, the present invention will build a “SELECT . . . ORDER-BY . . . ” clause 408 at a step 806, which will be further explained with reference to FIG. 8C. The “WHERE” clause 406 will be built at a step 808, which will be further illustrated with respect to FIG. 8D. The SQL statement is built at a step 809, including a “WHERE” clause 406 and an “ORDER-BY” clause 408 if either or both were created. Finally, the SQL statement will be executed and results displayed at a step 810.

Turning now to FIG. 8B, an embodiment of building a list of columns to select is referenced generally by numeral 804. This process generates the “SELECT” clause 402. At a step 811, a determination is made as to whether this is a distance search. If so, at a step 812, distance formula is added to the select list. If not, the present invention prepares to process the first search-criteria field entry at a step 814. At a step 816, a determination is made as to whether the field is to be displayed on the result page. If so, that field is added to the select-list 410 at a step 818. Next, a determination is made as to whether there are any remaining search-criteria entries to process at a step 820. If so, the next search-criteria entry is prepared to be processed at a step 824. Again, a determination is made as to whether this field is to be displayed at step 816. If the field is not to be displayed, a determination is made as to whether the field is to be sorted on at a step 826. If so, the field is added to select-list 410 at step 818. If the field is not to be sorted on, then a determination is made as to whether there are remaining search-criteria entries to process at step 820. If there are no more search-criteria entries remaining, the process ends.

Turning now to FIG. 8C, a process for building a “SELECT ORDER-BY” clause 408 is referenced generally by numeral 806. The sort fields for the view are selected in the sort order at a step 828. At a step 829, the first sort field is prepared to be processed. A decision is made as to whether a sort order is descending at a step 830. If no, the field is added to the sort-specification 416 at a step 832. A determination is then made at a step 833 as to whether there are remaining sort fields to process. If so, the next sort field is prepared to be processed at a step 834. The determination of whether this is a descending sort is again made at step 830. If so, the field is added to the sort-specification 416 with the keyword “DESC” at a step 835. This process repeats for as many fields as are to be sorted on.

Turning now to FIG. 8D, a preferred process for building a “WHERE” clause 406 is referenced generally by numeral 808. The “WHERE” clause 406 is started with no conditionals 414 at a step 836. Next, a determination is made as to whether the search is a distance search at a step 838. If the search is not a distance search, then conditionals 414 are built for text fields at a step 840, which will be further explained with reference to FIG. 8H. Conditionals 414 are then built from the selection-criteria fields of the specific view at a step 842. This process will be further illustrated with respect to FIG. 8F. The conditionals 414 can be built from selection-criteria fields that are not displayed. If the search was a distance search, then the latitude/longitude grid coordinate conditionals are appended to the “WHERE” clause 406 at a step 844, which will be further illustrated with respect to FIG. 8E. The conditionals from the selection-criteria fields are then built at a step 842.

Turning now to FIG. 8E, a process for appending the latitude/longitude grid coordinate conditionals to the “WHERE” clause 406 is referenced generally by numeral 844. At a step 846 a determination is made as to whether a valid postal code was entered. If so, then the latitude/longitude coordinates by postal code are retrieved at a step 848. Next, the latitude/longitude grid calculation is made at a step 850. At a step 852, the “WHERE” clause 406 is started with conditionals 414 for high/low, longitude/latitude coordinates. For example, one such conditional could read “WHERE LONGITUDE<high-longitude AND LONGITUDE>low-longitude AND LATITUDE<high-latitude AND LATITUDE>low-latitude.” This conditional will find all locations of an organization within a given LATITUDE and LONGITUDE parameter set. If a valid postal code has not been entered at step 846, then a determination would be made as to whether a valid city and state had been entered at a step 854. If so, the process would continue to a step 856. If not, an error message would be displayed at a step 858.

Turning now to FIG. 8F, a preferred process for building the “WHERE” conditionals 414 from selection-criteria fields is referenced generally by numeral 842. At a step 859, the first view selection-criteria field is processed. At step 860, a determination is made as to whether the selection-criteria field is hidden. Selection-criteria fields do not need to be displayed to an end-user 104 in order to be used to generate conditionals 414. Thus, if the selection-criteria field is a hidden field, then the conditional from the selection-criteria field's default value is appended to the “WHERE” clause 406 at a step 864, which will be further illustrated with reference to FIG. 8G.

A determination is made as to whether there are any remaining selection-criteria fields at a step 866. If so, the present invention prepares to process the next selection-criteria field at a step 868. Again, a determination is made as to whether the selection-criteria field is a hidden field at step 860. If not, a determination is made as to whether the end-user entered a value for the field at a step 870. If not, the present invention determines whether there are any remaining selection-criteria fields at step 866. If an end-user did make a selection at step 870, then a conditional is appended to the “WHERE” clause 406 based on the selection-criteria entry made by the end-user at a step 872, which will be further explained with reference to FIG. 8G. Next, a determination is made as to whether there are any remaining selection-criteria fields at step 866. If not, the process ends.

Turning now to FIG. 8G, a preferred process for appending conditionals 414 from selection-criteria fields is provided. The process illustrated in FIG. 8G can be used to append both default selections (step 864) and end-user selections (step 872) to a “WHERE” clause. At a step 878, a determination is made as to whether there are any matching data on the “locations” table 134. If so, then a “WHERE” conditional is built at a step 880 and the process ends. If there are no matching data on the location table then a join clause is built at a step 886 and the “WHERE” conditional is built at step 880. A join clause gathers data from multiple tables.

Turning now to FIG. 8H, a preferred process for building conditionals 414 from text fields is referenced generally by numeral 840. At a step 888, the first text search field entry is accepted. A determination is made as to whether the text field was a state or country text field at a step 890. If not, the “WHERE” conditional is built and appended to the “WHERE” clause 406 at a step 892. Then a determination is made as to whether there are any remaining text field entries at a step 894. If so, the next text search field entry is accepted at a step 896. Again, a determination is made as to whether the text field is a state or country text field at step 890. If so, a determination is made as to whether a valid abbreviation was entered at a step 897. If not, a “WHERE . . . LIKE . . . ” conditional is built and appended to the “WHERE” clause at a step 892. If a valid abbreviation was entered, then the full state or country name is substituted for the abbreviation at a step 898. This is done to match data entered by the end-user 104 with the full state and country names that are stored in the database 116. Storing full country and state names in the database 116 is included in a preferred embodiment, but is not intended to be a requirement or limitation of the present invention. Again, a determination is made as to whether there are any remaining text entries at step 894 after step 892. If there are not, the process ends.

Turning now to FIG. 9, a preferred method for displaying results to end-user 104 is referenced generally by numeral 810. At a step 901, the display fields for the view in the display order are selected. At a step 902, the visible column headings are displayed. At a step 904, the first location is prepared to be processed. At a step 906 the first display field is processed. Next, the location field is displayed in a row of the output grid at a step 908. Next, a determination is made as to whether there are any remaining display fields for this location at a step 910. If so, that location is displayed at step 908. This process repeats for as many fields for the specific location as are present. When there are no remaining display fields for the present location, then a determination is made as to whether there are any remaining locations at a step 912. If so, the next location is prepared to be processed at a step 914. Again, the location field is displayed with the grid at step 908. This process is repeated for as many display fields as there are locations at step 910. Finally, if there are no more remaining locations to process at step 912, the process ends.

While the methods disclosed herein have been described and shown with reference to particular steps performed in a particular order, it will be understood that these steps may be combined, subdivided, or reordered to form an equivalent method without departing from the teachings of the present invention. Accordingly, unless specifically indicated herein, the order and grouping of the steps is not a limitation of the present invention. The present invention can be implemented using a variety of computer-programming languages as would be understood by one of ordinary skill in the art. In a preferred embodiment, LINUX Server “C” Code is used in combination with PHP hyperscript processor (PHP) server-side scripting language, HTML and Javascript.

While various embodiments and particular applications of this invention have been shown and described, it is apparent to those skilled in the art that many other modifications and applications of this invention are possible without departing from the inventive concepts herein. It is, therefore, to be understood that within the scope of the appended claims, this invention may be practiced otherwise than as specifically described, and the invention is not to be restricted except in the spirit of the appended claims. Though some of the features of the invention may be claimed in dependency, each feature has merit if used independently.

What is claimed is:

1. A computer-readable medium having computer-useable code embodied thereon for assisting a user with development of a program that provides geographic location information of an organization via a plurality of search-specific page sets, wherein each of said plurality of search-specific page-sets comprises a unique set of search attributes, said computer-readable code, comprising:
code for defining a custom search page; and
code for defining a custom results page for displaying a query result.

2. The computer-readable medium of claim 1, wherein code for defining a custom search page comprises code for defining search criteria to be displayed on said custom search page.

3. The computer-readable medium of claim 2, wherein code for defining search criteria to be displayed on said custom search page comprises code for defining a plurality of search-criteria controls to be included on said custom search page, wherein said plurality of search-criteria controls solicit information from an end-user upon which to assemble a query statement.

4. The computer-readable medium of claim 3, wherein code for defining a plurality of search-criteria controls, comprises:
code for defining a selection-criteria field upon which to initiate a query;
code for defining a text field upon which to initiate a query; and
code for associating said custom search page with a network address.

5. The computer-readable medium of claim 4, wherein code for defining a selection-criteria field comprises designating said selection-criteria field as a hidden field.

6. The computer-readable medium of claim 5, further comprising code for defining a default value for said selection-criteria field.

7. The computer-readable medium of claim 6, further comprising code for defining a display position of said selection-criteria field.

8. The computer-readable medium of claim 7, further comprising code for associating a textual label with said selection-criteria field to be displayed on said custom search page.

9. The computer-readable medium of claim 4, wherein code for defining a text field, comprises:
code for designating a display position of said text field; and
code for associating a textual label with said text field to be displayed on said custom search page.

10. The computer-readable medium of claim 4, further comprising code for defining a views-link to be chosen by an end-user wherein said views-link links to one or more of said plurality of search-specific page-sets.

11. The computer-readable medium of claim 10, wherein code for defining a views-link includes code for defining a selection control, wherein said selection control lists at least one of said plurality of search-specific page-sets.

12. The computer-readable medium of claim 11, further comprising code for defining a default selection of said selection control.

13. The computer-readable medium of claim 10, wherein code for defining a views-link includes code for defining a hyperlink corresponding to one of said plurality of search-specific page-sets.

14. The computer-readable medium of claim 1, wherein said code for defining a custom results page includes code for defining a plurality of records-set headings to be displayed to an end-user, said record-set headings corresponding to a records-set returned in response to a search initiated by said end-user

15. The computer-readable medium of claim 14, further comprising code for defining a display format of said query result.

16. The computer-readable medium of claim 15, further comprising code for specifying a display order for said plurality of record-set headings to appear on said custom search page.

17. The computer-readable medium of claim 16, further comprising code for specifying a sort order of said record-set.

18. The computer-readable medium of claim 17, wherein said code for choosing said plurality of display fields comprises code for selecting whether the following display fields will be displayed to said end-user: name, address, city, state, postal code, phone, fax, contact, e-mail address, uniform resource locator, and product line information.

19. A computer programmed to execute the computer-useable code recited in of claim 1.

20. In a development system for creating computer programs, a method for assisting a user with development of a program that provides geographic location information of an organization, the method comprising:
providing a custom search page via said computer network;
associating said custom search page with a network address;
displaying said custom search page in response to navigating to said network address; and
displaying a custom results page in response to processing a query initiated by an end-user.

21. The method of claim 20, wherein providing a custom search page includes providing a plurality of search-criteria elements customized for a predefined search request.

22. The method of claim 21, further comprising enabling the creation of a user-defined custom search field.

23. The method of claim 21, wherein providing said plurality of search-criteria elements, comprises:
defining a list of choices to populate at least one of said plurality of search-criteria elements;
providing a selection-criteria control on said custom search page; and
prepopulating said selection-criteria control with said defined list whereby said search-criteria element is populated with a choice made from said defined list of said selection-criteria control.

24. The method of claim 21, wherein associating said custom search page with a network address, comprises:
associating a character string with said custom search page; and
appending said character string to a first network address, wherein said first network address corresponds to a default search page.

25. The method of claim 21, wherein associating said custom search page with a network address includes providing a views-link to be followed by an end-user wherein said views-link is linked to said custom search page.

26. The method of claim 25, wherein providing a views-link includes providing a selection-criteria control, wherein said selection-criteria control is comprised of a link to said custom search page.

27. The method of claim 26, wherein providing a views-link includes providing a hyperlink to said custom search.

28. The method of claim 21, wherein displaying said custom search page comprises displaying a portion of said plurality of said criteria elements.

29. The method of claim 28, further comprising:
determining which of said plurality of said search-criteria elements are to be hidden from view; and
displaying only those search-criteria elements that are not to be hidden from view.

30. The method of claim 29, further comprising:
determining whether each of said plurality of search-criteria elements contains a default value; and
displaying each of said plurality of search-criteria elements with its corresponding default value.

31. The method of claim 20, wherein displaying a custom results page comprises:
defining a plurality of records-set headings to display; and
defining a custom display format of said plurality of records.

32. The method of claim 31, further comprising:
defining a column width of said record-set headings;
defining a display order of said record-set headings; and
designating which of said record-set headings to sort on.

33. A computer programmed to perform the steps recited in the method of claim 20.

34. A method for providing geographic location information of an organization in a computer networking environment, comprising:
creating a first search page comprising a first set of search fields;
associating said first search page with a first network address;
creating a second search page comprising a second set of search fields;
associating said second search page with a second network address; and
making said first and second search pages accessible via said computer networking environment.

35. The method of claim 34, wherein making said first and second search pages accessible comprises:
associating said first network address with a first hypertext link;
associating said second network address with a first hypertext link; and
publishing said first and second network addresses on the Internet.

36. A method for creating a plurality of web pages to provide a user's product information to remote entities, comprising:
providing for a selection of a plurality of search-criteria fields to be displayed on a portion of said plurality of said web pages without a user having to type computer code;
providing for a processing of an end-user query without said user having to type computer code; and
providing for a display of said product information in response to said end-user query without said user having to type computer code.

37. The method of claim 36, wherein said creating said plurality of web pages, comprises
associating a plurality of search-criteria fields with a predefined search; and
creating a plurality of search-specific web pages wherein each of said web pages contains one of plurality of associated search-criteria fields.

38. A method for presenting physical location information of an organization via a data network, comprising the steps of:
providing for the establishment of a logical connection with a remote computer;
providing for a web page to be downloaded containing search-specific criteria fields to accept input from an end-user;
providing for a query statement to be created based on said input; and
providing for the presentation of said physical location information in response to be processing said query statement.

39. The method of claim 38, wherein said providing for a query statement to be created comprises building a Structured Query Language (SQL) statement.

40. The method of claim 39, wherein building said SQL statement comprises:
determining from a plurality of search-specific page-sets which page-set is to be used to create said query statement;
building a list of columns from a database logically coupled with said web page to select;
building an “ORDER-BY” clause of said SQL statement;
creating a conditional statement from said input by said end-user; and
incorporating said conditional into a “WHERE” clause of said SQL statement.

41. A method for creating a plurality of search-specific page-sets to provide an end-user with geographic product information of an organization wherein each of said plurality of search-specific page-sets comprises a unique set of search attributes, said computer-readable code comprising:
means for defining a custom search page; and
means for defining a custom results page for displaying a query result.
